(19) United States
(12) Patent Application Publication
(10) Pub. No.: US 2005/0266826 A1
(43) Pub. Date: Dec. 1, 2005

(54) Method for establishing a security association between a wireless access point and a wireless node in a UPnP environment

(75) Inventor: Stirbu Vlad, Tampere, FL (US)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/858,506

(22) Filed: Jun. 1, 2004

(51) Int. Cl. H04M 3/16

(52) U.S. Cl. 455/410; 455/411; 455/41.2

(57) ABSTRACT

A system and method provide for the intuitive establishment of a security association between devices. To join a network of devices, a user device sends user parameters for the user device to an administrator device using an out-of-band communication protocol. The administrator device sends the user parameters to an access point device using a Universal Plug and Play Simple Object Access Protocol (UPnP SOAP) Set action. The access point device saves the user parameters in a local database. The administrator device retrieves access point parameters from the access point device using the UPnP SOAP Get action. The administrator device sends the access point parameters to the user device using the out-of-band communication protocol. The user device connects to the access point device using the access point parameters to configure a secure connection. Preferably, a location limited channel is used by the user device to communicate with the administrator device.

### FIELD OF THE INVENTION

The present invention is related to wireless data transmission. More particularly, the present invention relates to a system and a method for establishing a security association between a wireless access point and a wireless node in a UPnP environment.

### BACKGROUND OF THE INVENTION

Stand-alone wireless networks connect devices over various distances from short to long, and generally, either provide their own security and encryption features or rely upon VPN's (Virtual Private Networks) to provide these features. The Institute of Electrical and Electronics Engineers (IEEE) establishes industry wide standards designed to resolve compatibility issues between manufacturers of various electronic equipment. The IEEE 802.11 ™ specifications define wireless standards for Wireless Local Area Networks (WLANs) that provide an “over-the-air” interface between a wireless client and a base station or access point, as well as among other wireless clients. The 802.11 WLAN concept is based on a cellular architecture such that the system is subdivided into cells that are controlled by a base station known as an access point. Multiple cells may be joined through their access points typically using Ethernet, but possibly using wireless technology or other network technologies.

The IEEE 802.15 Working Group provides standards for low-complexity and low-power consumption Wireless Personal Area Networks (PANs) such as those supported by the Bluetooth specification. The Bluetooth Special Interest Group (SIG) is driving the development of Bluetooth as a specification for low cost, short-range (0.1-100 meters) wireless communication between two devices.

Wireless link security is critically important for wireless networks because connectivity to the network is not restricted by the reach of wires or the availability of physical ports. As standardized by the IEEE, security for 802.11 WLANs can be subdivided into authentication and encryption components. Authentication is performed to allow a device to join a network, whereas encryption is primarily utilized after a device has joined a network to protect the data transmitted between devices from eavesdropping. One of the primary issues associated with the use of security in WLAN and Bluetooth PANs is the process of setting up the security parameters. Current proposals for both WLANs and Bluetooth PANs include an authentication process where information is exchanged between the device attempting to join the network and an access point or between two devices attempting to network to each other. For example, the Extensible Authentication Protocol-Transport Layer Security (EAP-TLS) uses digital public-key certificates to perform authentication. Using EAP-TLS, both the client and the server require digital certificates. The process of obtaining and entering the digital certificates is complex, especially when there are a number of client devices to manage.

Bluetooth security features are based on pairing two devices that support the Bluetooth protocol. The device users select and manually enter passwords or Personal Identification Numbers (PINs) into both devices. Selecting and typing PIN codes of sufficient length to provide security can be difficult for users. The Bluetooth device searches for devices in proximity and presents the user with a list of possible devices with which to network. The user then selects a device and is prompted for a PIN to enter into both devices. The paired Bluetooth devices generate a shared secret using the entered PIN.

Bluetooth security relies on the selected PIN code. In general, a proper PIN code should be an approximately 64 bit long random bit string. On many Bluetooth devices, the PIN code may be typed only in terms of numerals. A random PIN code of 64 bits requires a 20 digit long random number. Selecting and typing such PIN codes is difficult for the user. As a result, users often avoid this task by selecting a PIN code that is either too short or follows a systematic pattern that is more easily guessed. 2⁶⁴

The basic WLAN communication protocols do not include any security features. As a result, security extensions to the protocols, such as the Wireless Equivalent Privacy (WEP), have been developed. According to the current draft, the 802.11i extension provides security using a similar method to the Bluetooth pairing with the same limitations.

The term security association denotes a data structure that contains the cryptographic keys needed for securing a connection and the identity information about the other device, such as the network addresses or hostname. The difficult task in establishing a security association is the distribution and management of the needed cryptographic keys and of the identity information in a large network environment. Wireless technology standards and security protocols that specify the link layer security (WEP, Wi-Fi Protected Access (WPA), 802.11i, BT SIG, etc.) do not describe how the security parameters are inserted into the devices. The standards are concerned with specifying the parameters and the use of these parameters. In practice, these parameters must be typed manually by the user as related above. Additionally, the UPnP IGD Working Committee has specified in the WLAN access point how the WLAN access point is configured using a WLAN access point control point, but they do not specify how the control point receives the security parameters. In previous development efforts, the assignee of the present invention developed a concept to provision security parameters using a location-limited channel. However, this concept required support for the location-limited channel in all devices involved.

What is needed, therefore, is a user friendly, intuitive method of inserting security parameters in a wireless network. What is further needed is a system for inserting security parameters in a wireless network that simplifies the hardware implementation of at least some of the system devices.

### SUMMARY OF THE INVENTION

An exemplary embodiment of the invention relates to a user device for establishing a security association. The user device includes a memory, a location limiting component, a communication interface, and an electronic circuit. The memory holds a security association application. The location limiting component is configured to send user parameters to an administrator device and to receive access point parameters from the administrator device. The communication interface connects to an access point using the received access point parameters. The electronic circuit couples to the location limiting component and to the communication interface and executes the security association application. Preferably, the location limiting component may be further configured to use an out-of-band protocol and/or the location limiting component may communicate using a location limited channel. The electronic circuit may be a processor.

Yet another exemplary embodiment of the invention relates to an administrator device for establishing a security association. The administrator device includes a memory, a location limiting component, a communication interface, and an electronic circuit. The memory holds a security association application. The location limiting component is configured to receive user parameters from a user device, and send access point parameters to the user device. The communication interface communicates with an access point using a Universal Plug and Play Simple Object Access Protocol (UPnP SOAP). The electronic circuit couples to the location limiting component and to the communication interface and executes the security association application. Preferably, the location limiting component may be further configured to use an out-of-band protocol and/or the location limiting component may communicate using a location limited channel. The electronic circuit may be a processor. Preferably, the communication interface is further configured to send the received user parameters to the access point using a UPnP SOAP Set action and to retrieve the access point parameters from the access point using a UPnP SOAP Get action.

Still another exemplary embodiment of the invention relates to an access point device for establishing a security association. The access point device includes a communication interface, a memory, and a network communication interface. The communication interface receives user parameters from an administrator device using a Universal Plug and Play Simple Object Access Protocol (UPnP SOAP). The memory holds the received user parameters. The communication interface may be further configured to send access parameters to the administrator device using the UPnP SOAP. The network communication interface may comprise, but is not limited to, an Ethernet interface, a wireless local area network interface, and/or a Bluetooth interface.

Still another exemplary embodiment of the invention relates to a system for establishing a security association. The system includes a first device, a second device, and a third device. The first device includes a first device memory, a first location limiting component, a first communication interface, and a first electronic circuit. The first device memory holds a first security association application. The first location limiting component sends user parameters to a second device and receives access point parameters from the second device. The first communication interface connects to a third device using the received access point parameters. The first electronic circuit couples to the first location limiting component and to the first communication interface and executes the first security association application.

The second device includes a second memory, a second location limiting component, a second communication interface, and a second electronic circuit. The second memory holds a second security association application. The second location limiting component receives the user parameters from the first device and sends the access point parameters to the first device. The second communication interface communicates with the third device using a Universal Plug and Play Simple Object Access Protocol (UPnP SOAP). The second electronic circuit couples to the second location limiting component and to the second communication interface and executes the second security association application.

The third device includes a third communication interface, a third memory, and a network communication interface. The third communication interface receives the user parameters from the second device using the UPnP SOAP. The third memory holds the received user parameters. The network communication interface may comprise, but is not limited to, an Ethernet interface, a wireless local area network interface, and/or a Bluetooth interface.

Preferably, the first location limiting component may be further configured to use an out-of-band protocol and/or the location limiting component may communicate using a location limited channel. The first electronic circuit may be a processor. Preferably, the second location limiting component may be further configured to use an out-of-band protocol and/or the location limiting component may communicate using a location limited channel. The second electronic circuit may be a processor. Preferably, the second communication interface is further configured to send the received user parameters to the third device using a UPnP SOAP Set action and to retrieve the access point parameters from the third device using a UPnP SOAP Get action. Preferably, the third communication interface is further configured to send access parameters to the second device using the UPnP SOAP.

Still another exemplary embodiment of the invention relates to a method of establishing a security association. The method includes sending user parameters from a user device to an administrator device using an out-of-band communication protocol, sending the user parameters from the administrator device to an access point using a Universal Plug and Play Simple Object Access Protocol (UPnP SOAP), saving the user parameters in a local database at the access point, retrieving access point parameters from the access point by the administrator device using the UPnP SOAP, and sending the access point parameters from the administrator device to the user device using the out-of-band communication protocol. Sending the user parameters from the user device to the administrator device may be performed using a location limited channel. Sending the access point parameters from the administrator device to the user device may be performed using the location limited channel. Sending the user parameters from the administrator device to the access point may be performed using a UPnP SOAP Set action and retrieving the access point parameters from the access point may be performed using a UPnP SOAP Get action. The access point may comprise a network bridge.

Still another exemplary embodiment of the invention relates to a computer program product for establishing a security association at a user device. The computer program product includes computer code configured to send user parameters to an administrator device using an out-of-band communication protocol, to receive access point parameters from the administrator device using the out-of-band communication protocol, and to connect to an access point using the received access point parameters. The computer code may further be configured to send the user parameters to the administrator device using a location limited channel and to receive access point parameters from the administrator device using the location limited channel.

Still another exemplary embodiment of the invention relates to a computer program product for establishing a security association for a second device using an administrator device. The computer program product includes computer code configured to receive user parameters from a user device using an out-of-band communication protocol, to send the user parameters to an access point using a Universal Plug and Play Simple Object Access Protocol (UPnP SOAP), to retrieve access point parameters from the access point using the UPnP SOAP, and to send the access point parameters to the user device using the out-of-band communication protocol. The computer code may further be configured to receive the user parameters from the user device using a location limited channel and to send the access point parameters to the user device using the location limited channel. The computer code may further be configured to send the user parameters to the access point using a UPnP SOAP Set action and to retrieve the access point parameters from the access point using a UPnP SOAP Get action.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of a system in accordance with an exemplary embodiment.

FIG. 2 is a block diagram of a user device in accordance with an exemplary embodiment.

FIG. 3 is a block diagram of an administrator device in accordance with an exemplary embodiment.

FIG. 4 is a block diagram of an access point in accordance with an exemplary embodiment.

FIG. 5 is an overview diagram of a message sequence in accordance with an exemplary embodiment.

### DETAILED DESCRIPTION OF THE PREFERRED EMBODIMENTS

Universal Plug and Play (UPnP™) defines an architecture for the network connectivity of intelligent appliances, wireless devices, and PCs of all form factors. The goal of UPnP technology is to provide easy-to-use, flexible, standards-based connectivity for ad-hoc or unmanaged networks whether in a home, in a small business, or in public spaces. In support of this goal, UPnP supports zero-configuration, “invisible” networking, and the automatic discovery of devices from a wide range of manufacturers. As a result, a device can dynamically join a network, obtain an IP address, convey its capabilities to the network, and determine the presence and capabilities of other devices. UPnP also provides a consistent, interoperable framework for remote Internet Gateway Device (IGD) configuration and management.

An IGD is an IP addressable device that typically resides at the edge of a home or a small-business network. The IGD interconnects at least one LAN with a Wide Area Network (WAN) such as the Internet. The IGD also provides local addressing and routing services between one or more LAN segments and to and from the Internet. The IGD may be physically implemented as a dedicated, standalone device or included as a set of UPnP devices and services on a PC. The IGD or firewall secures a LAN from the Internet to the extent that it blocks unsolicited traffic from the outside.

As discussed previously, WLAN refers to local networks with wireless radio connections. The IEEE 802.11 standard specifies many different WLAN protocols. The WLAN standards specify two approaches to LAN operation, the infrastructure approach and the ad hoc networking approach. Using the infrastructure approach, all of the WLAN devices are connected to a central access point. This access point is typically connected to a fixed network or networks and thus, provides infrastructure support for all the devices of the WLAN.

With the widespread adoption of the 802.11 standard in devices, the UPnP IGD Working Committee includes the WLAN Access Point as a device that implements the IEEE 802.11 wireless standards and provides an infrastructure network for home or for small business networks. The UPnP IGD Working Committee additionally includes a Bluetooth Access Point as a device that implements the Bluetooth SIG wireless standards to provide an infrastructure network for a home or for small business networks. Both the WLAN Access Point device and the Bluetooth Access Point device may act as an Ethernet bridge that enables the attachment of multiple nodes to a LAN. Ethernet is a LAN architecture, and the Ethernet specification serves as the basis for the IEEE 802.3 standard, one of the most widely implemented LAN standards. A bridge device connects two LANs or two segments of the same LAN that use the same protocol.

UPnP is an open networking architecture that consists of services, devices, and control points. Control points are essentially software applications and are the active components of the UPnP architecture. Devices are physical or logical entities, enumerated via simple eXtensible Markup Language (XML) descriptions and containing Application Programming Interfaces (APIs) referred to as services. Physical devices may host multiple logical devices, and each device may host multiple services. Services are groups of states and actions. For example, a light switch has an “on” state and an “off” state. An action allows the network to determine the state of the switch or to change the state of the switch. Services typically reside in devices.

Messages are transported over UPnP networks using the Hypertext Transmission Protocol (HTTP) over the User Datagram Protocol/Internet Protocol (UDP/IP) or the Transmission Control Protocol/Internet Protocol (TCP/IP). The supported message formats are Simple Service Discovery Protocol (SSDP), General Event Notification Architecture (GENA), and Simple Object Access Protocol (SOAP). UPnP relies on these three protocols to enable networking without a classical network administrator. The basic UPnP protocol does not include security. SSDP provides for the discovery of devices on the network and is difficult to secure. GENA provides for subscribing to event reports and for the publication of those events. GENA is secured by controlling subscription to events and encrypting the events. SOAP provides for control of the network devices through remote procedure calls between control points and devices. SOAP is secured by allowing only authorized control points to invoke any secured action within a device. In brief, SOAP is secured by allowing only authorized control points to invoke any secured action within a device. This is accomplished by an Access Control List (ACL) in each secured device, each of the entries of which lists a control point unique ID, a name of a group of control points, or the universal group “<any/>.” The ACL entries also specify what that control point or group is allowed to do on that device.

The UPnP Device Security Service provides the services necessary for strong authentication, authorization, replay prevention, and privacy of UPnP SOAP actions. Under this architecture, a device enforces its own access control, but its access control policy is established and maintained by an administrative application called the Security Console. The UPnP Security Console Service edits the ACL of a secured UPnP device and controls other security functions of that device. Thus, UPnP Security is provided by a pair of services, Device Security and Security Console. Device Security implements access control for itself and for other services in the same device. A primary function of the Security Console is to enable a user to select from physically accessible devices and control points external to the device.

The Security Console is a combination device and control point that can be a separate component or part of some other component. Its purpose is to take security ownership of devices and then to authorize control points (or other Security Consoles) to have access to devices over which the Security Console has control. A control point does not need to be exclusive about which Security Console it advertises itself to. The control point is the beneficiary of grants of authority and all decision making is done by the Security Console. The situation, however, is reversed for devices. A device has the resources (SOAP Actions) to which access must be restricted. The Security Console, by editing the device's ACL, tells the device which control points to obey. Therefore, the device should be very selective in determining to which Security Console the device associates.

Based on the generic ownership protocol defined by UPnP Security, the Security Console can take ownership of a device only if the Security Console knows the device's secret password and the device is not already owned. Once a device is owned, a Security Console that owns it can grant co-ownership to another Security Console or revoke it, but more importantly, a Security Console that owns a device can completely re-write the device's ACL.

Recent academic research has introduced the idea of using “location-limited channels,” such as infrared or short range radio connections, for proximity based user friendly authentication. The location-limited channel can be used to exchange initial security information, such as keys and addresses, between devices that are physically close to each other. Because the communicating devices are close to each other, the user can ascertain whether the device is an adversary or not. After the location-limited channel security authentication, a secure connection can be created for the main communication link.

In an out-of-band communication protocol, the signaling information travels on a separate network path parallel to the data. By using this type of design, the user and signaling packets are never confused because separate paths are used. As a result, no additional overhead is required to differentiate between the signal and the user packet. A location-limited channel is a separate channel from the main communication link.

There are many different kinds of location-limited channels. Some location-limited channels are one-way. For example, reading the Radio Frequency IDentification (RFID) tag of an airport printer only requires one-way communication. Other location-limited channels are two-way. For example, the infrared link between a digital camera and a computer requires two-way communication between the devices. Some location-limited channels have high bandwidth, while others are capable of sending only a small amount of information. A location-limiting component is the actual physical component, such as the infrared port, that sends and receives the messages through the location-limited channel. Typically, most of the location-limiting components that provide a location-limited channel can both send and receive messages. Location limited channels may be based on infrared, audio, optical, laser, RFID, range reduced Bluetooth, wired connection, etc.

The Infrared Data Association (IrDA) defines a standard for an interoperable, universal, two-way cordless infrared light transmission data port. The infrared data port can be used for high speed, short range, line-of-sight data transfer. RFID is similar in theory to bar code identification. An RFID system consists of an antenna and a transceiver that reads the radio frequency and transfers the information to a processing device, and a transponder that is an integrated circuit containing the RF circuitry and information to be transmitted. RFID eliminates the need for line-of-sight reading. Also, RFID scanning can be done at greater distances than bar code scanning.

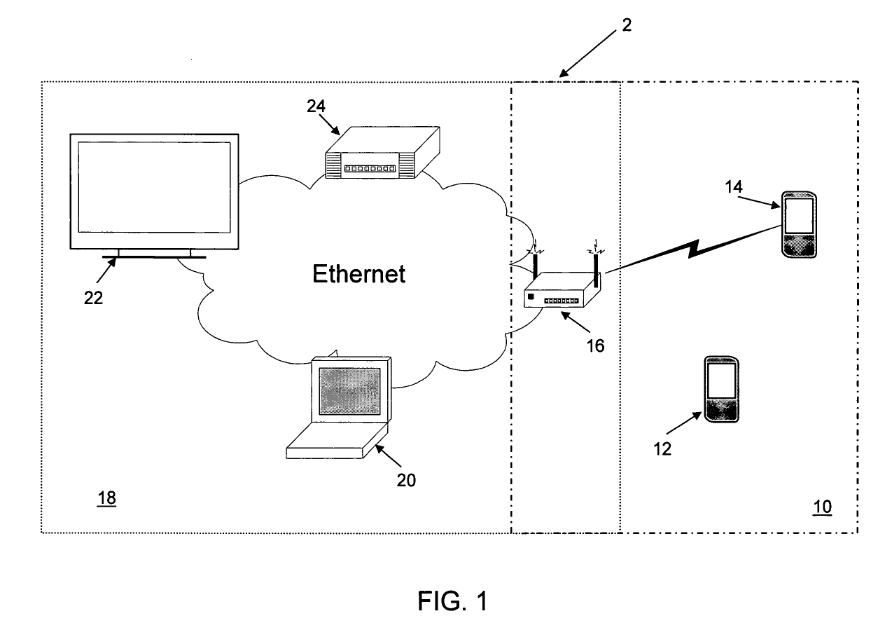

With reference to FIG. 1, the system 2 comprises a wireless network 10 and an Ethernet network 18. The wireless network 10 comprises a user device 12, an administrator device 14, and an access point 16. The user device 12 and the administrator device 14 may comprise a cellular telephone, an Instant Messaging Device (IMD), a Personal Data Assistant (PDA), a PC of any form factor, and other devices that can communicate using various transmission technologies (including CDMA, GSM, TDMA, Bluetooth, and others) or media (radio, infrared, laser, and the like). The wireless network 10 may include additional devices 12.

The Ethernet network 18 comprises the access point 16, a laptop 20, a TV 22, and a Personal Video Recorder (PVR) 24. In the exemplary embodiment of FIG. 1, the access point 16 is an Ethernet bridge between the wireless network 10 and the Ethernet network 18. The access point 16 may transmit wirelessly using WLAN or Bluetooth protocols. The system 2 may comprise any combination of wired or wireless networks including, but not limited to, a cellular network, WLAN, Bluetooth PAN, Ethernet LAN, token ring LAN, WAN, etc. The system 2 may include other wired and wireless devices including, but not limited to, intelligent appliances and PCs of all form factors.

Connecting a device to another device may be through one or more of the following connection methods without limitation: a link established according to the Bluetooth Standards and Protocols, an infrared communications link, a wireless communications link, a cellular network link, a physical serial connection, a physical parallel connection, a link established according to TCP/IP, etc.

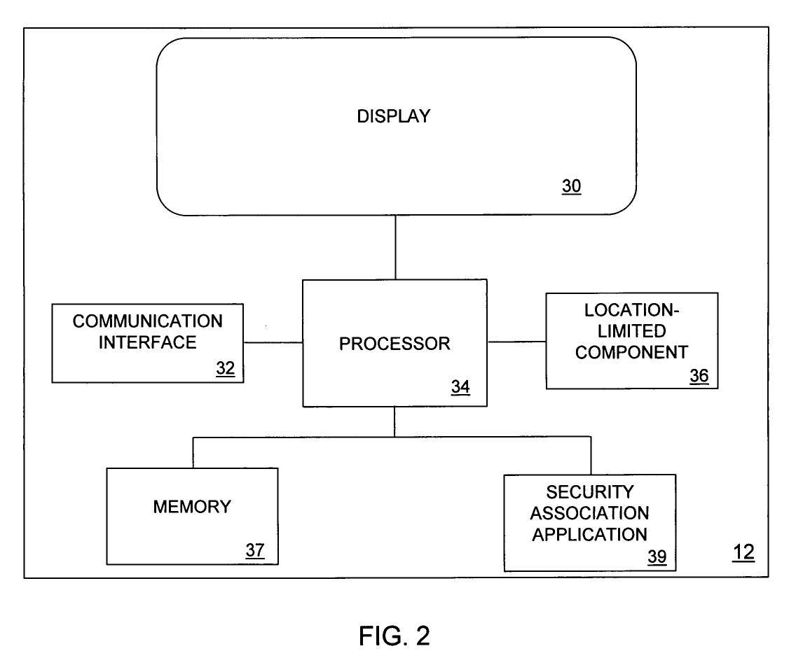

With reference to FIG. 2, the user device 12 comprises a display 30, a communication interface 32, a processor 34, a location-limiting component 36, a memory 37, and a security association application 39. The term “device” should be understood to include, without limitation, cellular telephones, PDAs, such as those manufactured by PALM, Inc., IMD, such as those manufactured by Blackberry, Inc., and other hand-held devices; PCs of any form factor; etc. The exact architecture of the user device 12 is not important. Different and additional components may be incorporated into the user device 12.

The display 30 of the user device 12 is optional. The display 30 presents information to a user. The display 30 may be a thin film transistor (TFT) display, a light emitting diode (LED) display, a Liquid Crystal Display (LCD), or any of a variety of different displays known to those skilled in the art.

The communication interface 32 provides an interface for receiving and transmitting calls, messages, and any other information communicable between devices. Communications between the user device 12, the administrator device 14, and the access point 16 may be through one or more of the following connection methods, without limitation: an infrared communications link, a wireless communications link, a cellular network link, a link established according to TCP/IP, etc. Transferring content to and from the device may use one or more of these connection methods.

The processor 34 executes instructions that cause the user device 12 to behave in a predetermined manner. The instructions may be written using one or more programming languages, scripting languages, assembly languages, etc. Additionally, the instructions may be carried out by a special purpose computer, logic circuits, or hardware circuits. Thus, the processor 34 may be implemented in hardware, firmware, software, or any combination of these methods. The term “execution” is the process of running a program or the carrying out of the operation called for by an instruction. The processor 34 executes an instruction, meaning that it performs the operations called for by that instruction. The processor 34 executes the instructions embodied in the security association application 39. The security association application 39 controls the initiation and maintenance of a security association between devices.

The location-limiting component 36 may provide an interface to a location-limited channel based on infrared, audio, optical, laser, RFID, range reduced Bluetooth, wired connection, etc. The memory 37 may include volatile memory and/or non-volatile memory including Random access Memory (RAM), Read Only Memory (ROM), magnetic or optical disk drives, Flash memory, etc. The user device 12 may include one or more memories 37 of the same or different type.

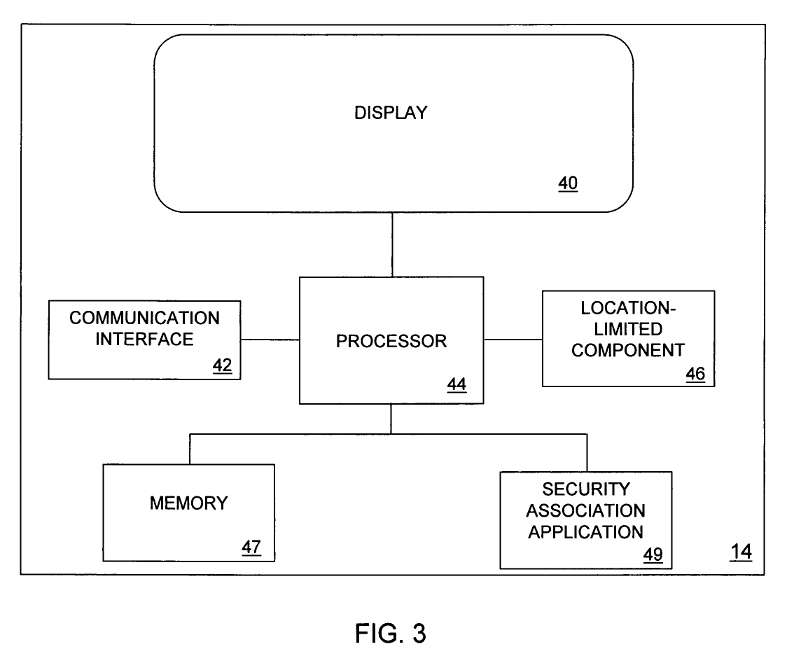

With reference to FIG. 3, the administrator device 14 comprises a display 40, a communication interface 42, a processor 44, a location-limiting component 46, a memory 47, and a security association application 49. The exact architecture of the administrator device 14 is not important. Different and additional components may be incorporated into the administrator device 14.

The display 40 of the administrator device 14 is optional. The display 40 presents information to a user. The display 40 may be a thin film transistor (TFT) display, a light emitting diode (LED) display, a Liquid Crystal Display (LCD), or any of a variety of different displays known to those skilled in the art. The communication interface 42 provides an interface for receiving and transmitting calls, messages, and any other information communicable between devices.

The processor 44 executes instructions that cause the administrator device 14 to behave in a predetermined manner. The instructions may be written using one or more programming languages, scripting languages, assembly languages, etc. Additionally, the instructions may be carried out by a special purpose computer, logic circuits, or hardware circuits. Thus, the processor 44 may be implemented in hardware, firmware, software, or any combination of these methods. The processor 44 executes an instruction, meaning that it performs the operations called for by that instruction. The processor 44 executes the instructions embodied in the security association application 49. The security association application 49 controls the initiation and maintenance of a security association between devices.

The location-limiting component 46 may provide an interface to a location-limited channel based on infrared, audio, optical, laser, RFID, range reduced Bluetooth, wired connection, etc. The memory 47 may include volatile memory and/or non-volatile memory including RAM, ROM, magnetic or optical disk drives, Flash memory, etc. The administrator device 14 may include one or more memories 47 of the same or different type.

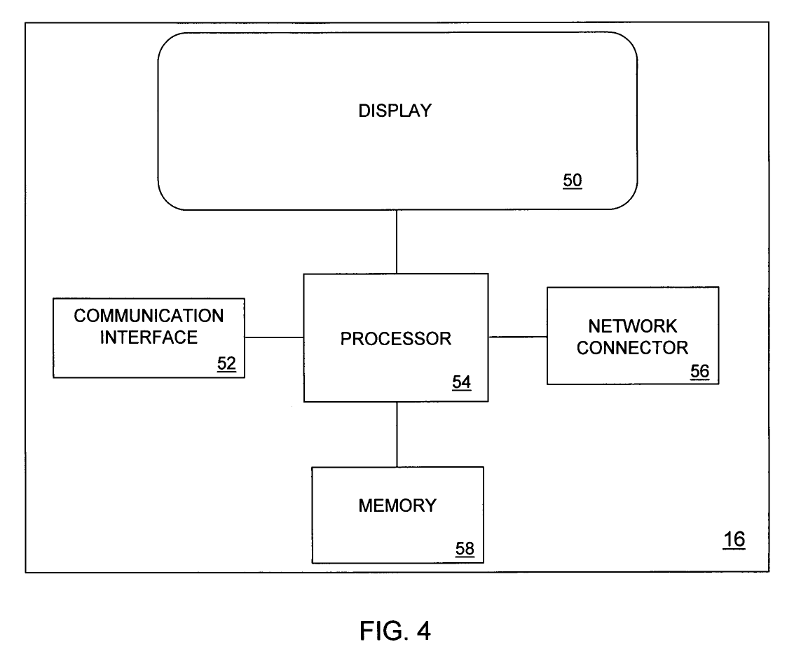

With reference to FIG. 4, the access point 16 comprises a display 50, a communication interface 52, a processor 54, a network connector 56, and a memory 58. The exact architecture of the access point 16 is not important. Different and additional components may be incorporated into the access point 16.

The display 50 of the access point 16 is optional. The display 50 presents information to a user. The display 50 may be a thin film transistor (TFT) display, a light emitting diode (LED) display, a Liquid Crystal Display (LCD), or any of a variety of different displays known to those skilled in the art. The communication interface 52 provides an interface for receiving and transmitting calls, messages, and any other information communicable between devices.

The processor 54 executes instructions that cause the access point 16 to behave in a predetermined manner. The instructions may be written using one or more programming languages, scripting languages, assembly languages, etc. Additionally, the instructions may be carried out by a special purpose computer, logic circuits, or hardware circuits. Thus, the processor 54 may be implemented in hardware, firmware, software, or any combination of these methods.

The network connector 56 provides an interface to the network 18. In an exemplary embodiment, the network connector is an Ethernet network connector. The memory 58 may include volatile memory and/or non-volatile memory including RAM, ROM, magnetic or optical disk drives, Flash memory, etc. The access point 16 may include one or more memories 58 of the same or different type.

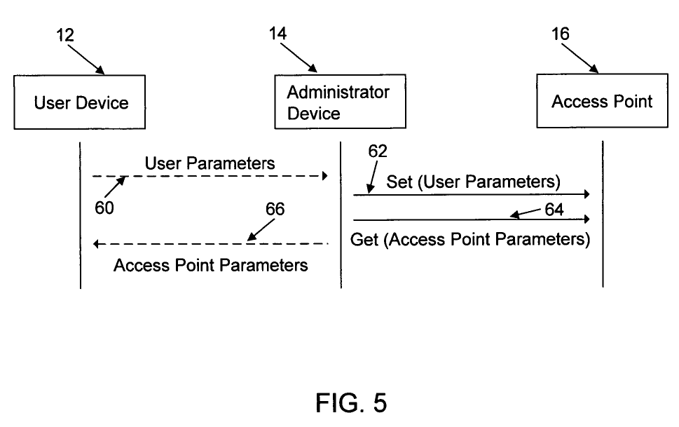

In operation, the access point 16 hosts either a UPnP WLAN or Bluetooth Access Point service and a UPnP Device Security service. The administrator device 14 hosts a UPnP WLAN or Bluetooth Access Point secure control point. The administrator device 14 establishes ownership of the access point 16 using the UPnP security framework. As a result, a UPnP security association exists between the access point 16 and the administrator device 14. With reference to FIG. 5, the user device 12 wants to establish an association with the access point 16 in order to access the network 10 and/or the network 18. To do so, the user device 12 contacts the administrator device 14 requesting access rights to the network 10 and/or the network 18. In an exemplary embodiment, the communication between the user device 12 and the administrator device 14 uses an out-of-band protocol. Preferably, the out-of-band protocol works over a location-limited channel.

The user device 12 initiates the security procedure by sending the user parameters, at operation 60, using the location-limited channel. The administrator device 14 receives these parameters and, preferably using a UPnP SOAP Set action, sends the user parameters to the access point 16 at operation 62. The access point 16 saves the user parameters in the memory 58 that may comprise a local database. The UPnP Set action and Get action are normal SOAP actions for setting or defining the value of a parameter and for getting or fetching the value of a parameter respectively. The administrator device 14 retrieves access point parameters using a UPnP SOAP Get action at operation 64. The administrator device 14 sends the access point parameters over the location-limited channel to the user device 12 at operation 66. A security association between the access point 16 and the user device 12 is created. The user device 12 accesses the network 10 and/or the network 18 through the access point 16 in a secure way by having the link layer security enabled. Preferably, the administrator device 14 and the access point 16 are UPnP devices. The user device 12 may or may not be a UPnP device.

The user parameters and access point parameters vary based on the type of interface, the devices used, the authentication protocol, etc. In a first example use case, the user device 12 is equipped with a WLAN interface and wants to access the network 10 and/or the network 18 using a WLAN access point 16 that uses a Medium Access Control (MAC) filter to allow only known nodes to connect to the network 10 and/or the network 18 and WEP for link layer security. The user parameters in the first example use case are the WLAN MAC address of the user device 12. The access point parameters in the first example use case are the Service Set Identifier (SSID) and the WEP password of the access point 16. The SSID is typically a 32-character unique identifier attached to the header of packets sent over a WLAN. The SSID acts as a password when a device tries to connect to the access point 16. The SSID differentiates one WLAN from another, so all access points and all devices attempting to connect to a specific WLAN must use the same SSID.

In a second example use case, the user device 12 is equipped with a Bluetooth interface that supports a Bluetooth PAN. The user device 12 wants to connect to the network 10 and/or the network 18 using the a Bluetooth PAN access point 16. The user parameters in the second example use case are the Bluetooth address of the user device 12. The access point parameters in the second example use case are the Bluetooth address of the access point 16 and a PIN.

It is understood that the invention is not confined to the particular embodiments set forth herein as illustrative, but embraces all such modifications, combinations, and permutations as come within the scope of the following claims. Thus, the description of the exemplary embodiments is for purposes of illustration and not limitation.

1. A user device for establishing a security association, the user device comprising:
a memory that holds a security association application;
a location limiting component, wherein the location limiting component is configured to:
send user parameters to an administrator device; and
receive access point parameters from the administrator device;
a communication interface, wherein the communication interface connects to an access point using the received access point parameters; and
an electronic circuit coupled to the location limiting component and to the communication interface to execute the security association application.

2. The device of claim 1, wherein the electronic circuit is a processor.

3. The device of claim 1, wherein the location limiting component is further configured to use an out-of-band protocol.

4. The device of claim 1, wherein the location limiting component communicates using a location limited channel.

5. An administrator device for establishing a security association, the administrator device comprising:
a memory that holds a security association application;
a location limiting component, wherein the location limiting component is configured to:
receive user parameters from a user device; and
send access point parameters to the user device;
a communication interface, wherein the communication interface is configured to communicate with an access point using a Universal Plug and Play Simple Object Access Protocol (UPnP SOAP); and
an electronic circuit coupled to the location limiting component and to the communication interface to execute the security association application.

6. The device of claim 5, wherein the electronic circuit is a processor.

7. The device of claim 5, wherein the location limiting component is further configured to use an out-of-band protocol.

8. The device of claim 5, wherein the location limiting component communicates using a location limited channel.

9. The device of claim 5, wherein the communication interface is further configured to send the received user parameters to the access point using a UPnP SOAP Set action.

10. The device of claim 5, wherein the communication interface is further configured to retrieve the access point parameters from the access point using a UPnP SOAP Get action.

11. An access point device for establishing a security association, the access point device comprising:
a communication interface, wherein the communication interface is configured to receive user parameters from an administrator device using a Universal Plug and Play Simple Object Access Protocol (UPnP SOAP);
a memory that holds the received user parameters; and
a network communication interface.

12. The device of claim 11, wherein the communication interface is further configured to send access parameters to the administrator device using the UPnP SOAP.

13. The device of claim 11, wherein the network communication interface comprises an Ethernet interface.

14. The device of claim 11, wherein the network communication interface comprises a wireless local area network interface.

15. The device of claim 11, wherein the network communication interface comprises a Bluetooth interface.

16. A system for establishing a security association, the system comprising:
a first device, the first device comprising:
a first device memory that holds a first security association application;
a first location limiting component, wherein the first location limiting component is configured to:
send user parameters to a second device; and
receive access point parameters from the second device;
a first communication interface, wherein the first communication interface connects to a third device using the received access point parameters; and
a first electronic circuit coupled to the first location limiting component and to the first communication interface to execute the first security association application;
the second device comprising:
a second memory that holds a second security association application;
a second location limiting component, wherein the second location limiting component is configured to:
receive the user parameters from the first device; and
send the access point parameters to the first device;
a second communication interface, wherein the second communication interface is configured to communicate with the third device using a Universal Plug and Play Simple Object Access Protocol (UPnP SOAP); and
a second electronic circuit coupled to the second location limiting component and to the second communication interface to execute the second security association application; and
the third device comprising:
a third communication interface, wherein the third communication interface is configured to receive the user parameters from the second device using the UPnP SOAP;
a third memory that holds the received user parameters; and
a network communication interface.

17. The system of claim 16, wherein the first location limiting component is further configured to use an out-of-band protocol.

18. The system of claim 16, wherein the second location limiting component is further configured to use an out-of-band protocol.

19. The system of claim 16, wherein the first location limiting component communicates using a location limited channel.

20. The system of claim 16, wherein the second location limiting component communicates using a location limited channel.

21. The system of claim 16, wherein the second communication interface is further configured to send the received user parameters to the third device using a UPnP SOAP Set action.

22. The system of claim 16, wherein the second communication interface is further configured to retrieve the access point parameters from the third device using a UPnP SOAP Get action.

23. The system of claim 16, wherein the third communication interface is further configured to send the access parameters to the second device using the UPnP SOAP.

24. The system of claim 16, wherein the network communication interface comprises an Ethernet interface.

25. The system of claim 16, wherein the network communication interface comprises a wireless local area network interface.

26. The system of claim 16, wherein the network communication interface comprises a Bluetooth interface.

27. A method of establishing a security association, the method comprising:
sending user parameters from a user device to an administrator device using an out-of-band communication protocol;
sending the user parameters from the administrator device to an access point using a Universal Plug and Play Simple Object Access Protocol (UPnP SOAP);
saving the user parameters in a local database at the access point;
retrieving access point parameters from the access point by the administrator device using the UPnP SOAP; and
sending the access point parameters from the administrator device to the user device using the out-of-band communication protocol.

28. The method of claim 27, wherein sending the user parameters from the user device to the administrator device is performed using a location limited channel.

29. The method of claim 27, wherein sending the access point parameters from the administrator device to the user device is performed using a location limited channel.

30. The method of claim 27, wherein sending the user parameters from the administrator device to the access point is performed using a UPnP SOAP Set action.

31. The method of claim 27, wherein retrieving the access point parameters from the access point by the administrator device is performed using a UPnP SOAP Get action.

32. The method of claim 27, wherein the access point comprises a network bridge.

33. A computer program product for establishing a security association at a user device, the computer program product comprising:
computer code configured to:
send user parameters to an administrator device using an out-of-band communication protocol;
receive access point parameters from the administrator device using the out-of-band communication protocol; and
connect to an access point using the received access point parameters.

34. The computer program product of claim 33, wherein the computer code is further configured to send the user parameters to the administrator device using a location limited channel.

35. The computer program product of claim 33, wherein the computer code is further configured to receive the access point parameters from the administrator device using a location limited channel.

36. A computer program product for establishing a security association for a second device using an administrator device, the computer program product comprising:
computer code configured to:
receive user parameters from a user device using an out-of-band communication protocol;
send the user parameters to an access point using a Universal Plug and Play Simple Object Access Protocol (UPnP SOAP);
retrieve access point parameters from the access point using the UPnP SOAP; and
send the access point parameters to the user device using the out-of-band communication protocol.

37. The computer program product of claim 36, wherein the computer code is further configured to receive the user parameters from the user device using a location limited channel.

38. The computer program product of claim 36, wherein the computer code is further configured to send the access point parameters to the user device using a location limited channel.

39. The computer program product of claim 36, wherein the computer code is further configured to send the user parameters to the access point using a UPnP SOAP Set action.

40. The computer program product of claim 36, wherein the computer code is further configured to retrieve the access point parameters from the access point using a UPnP SOAP Get action.
